(19) United States
(12) Patent Application Publication
(10) Pub. No.: US 2005/0219222 A1
(43) Pub. Date: Oct. 6, 2005

(54) Touch sensitive display device

(75) Inventors: Mark Thomas Johnson, Eindhoven (NL); Simon Robert Marsh, Eindhoven (NL); Galileo June Adeva Destura, Eindhoven (NL); Ronaldus Maria Aarts, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., Eindhoven (NL)

(21) Appl. No.: 10/511,258

(22) PCT Filed: Mar. 20, 2003
(86) PCT No.: PCT/IB03/01059

§ 371 Date: Oct. 13, 2004

(30) Foreign Application Priority Data
Apr. 15, 2002 (EP) 02076461.9

(51) Int. Cl. G09G 5/00

(52) U.S. Cl. 345/173

(57) ABSTRACT

In a touch sensor the change in electrical characteristics (impedance, piezo-voltage) of spacing elements (13,14,15,25), provided with an conducting, resistive or piezo-electric layer (15, 25), are measured to determine the sensing area.

The invention relates to a touch sensitive display device comprising a multiple of picture elements between two substrates, having spacing means between the substrates and means for applying driving voltages to at least one of said picture elements together with means for monitoring the electrical characteristics of at least one of said picture elements and sensing a change in said electrical characteristics.

The display device is for instance a liquid crystal display device. Liquid crystal display devices have found widespread use in the computer industry and in handheld devices ranging from mobile telephones and price tags to palm top computers and organizers. Also the combination with a touching device such as a stylus has found widespread applications, while also a need for ways of providing input via the display screen is felt.

U.S. Pat. No. 5,777,596 describes a touch sensitive liquid crystal display device that allows putting input into the associated device (e.g. a computer) by simply touching the display screen with a finger, a stylus or a pen. The device continuously compares the charge time of the liquid crystal display elements (picture elements) to a reference value and uses the result of the comparison to determine which elements are being touched.

One of the problems in said touch sensitive liquid crystal display device resides in restoring the right image after sensing. This is due to the fact that a blinking line is used which represents the switching of all picture elements in a row between two extreme states. When the blinking line reaches a certain row touching is detected by measuring the charging time of the picture elements. After measuring the picture elements are provided with adequate voltages to display the right image. In a similar way sensing by means of a blinking spot is disclosed in U.S. Pat. No. 5,777,596.

Such blinking however is visible on the display (artifacts)

Moreover, if a reflective display device is used, internal DC bias voltages may be present whereby charging differs for writing odd or even frames. in DC driving methods (low power liquid crystal displays, electrophoresis) no inversion occurs so the method cannot be used at all there.

The invention has among others as its goal to overcome these objections.

It has as a further goal to introduce more functionality into the touch sensitive liquid crystal display device.

To this end in a touch sensitive display device according to the invention the spacing means are part of said means for monitoring the electrical characteristics. Said electrical characteristics may be capacitive, (non-linear) resistive or piezo-electric characteristics.

In fact the invention provides a method of non-interactive measuring; the method of measuring does not interfere with the providing of driving voltages to the picture elements.

This does not only overcome the problem of providing blinking signals but also, in certain embodiments offers new possibilities of touch sensing such as
i) sensing touch inputs at different places on the display screen
ii) disabling part of the display screen for touch sensing.

Both possibilities offer substantial advantages both in computer and telecommunication applications.

Sensing touch inputs at different places on the display screen offer possibilities such as detecting the impact of fingers or pencils on different places of the display screen. This is a useful item in e.g. flat screen (computer) devices in which the keyboard functions have been realized as touch functions on the screen. It is for example possible to detect simultaneous touching of CRTL, ALT and DEL pressing; in e.g. drawing programs the simultaneous touching of two points with a pen may immediately display a straight line, while at the same time via a third touching (area) this line may receive a certain curvature or hatching or for implementing gaming applications etc.

Disabling part of the display screen for touch sensing may be used in a cellular phone preventing the read out from being disturbed. On the other hand data input, e.g. obtained via the Internet may prevent certain parts (displaying logos) to be disturbed or disable certain menu bars for unauthorized users.

Dependent on the application sensing itself may be performed in different ways, varying from a simple four-point measurement to measuring a current, a change in voltage or a change in frequency.

In one embodiment the spacing means at least have a conducting part. For some methods of sensing it is advantageous if the conducting part of the spacing means forms a grid.

In other embodiments the spacing means comprise a (non-linear) resistive or a piezoelectric part. Also in this case it may be advantageous if the resistive or a piezoelectric part of the spacing means forms a grid.

One of the solutions according to the invention is to ensure that many pixels along the column (or row) are sensed at the same moment. In this case, the touch signal will increase with the number of pixels being sensed, whilst the background impedance will remain constant. In this way the signal to noise ratio will increase.

To this end in a first embodiment of a touch sensitive display device the means for monitoring impedance monitor at least one row of picture elements, while in a second embodiment the means for monitoring impedance monitor at least one column of picture elements. Also monitoring of the impedance of a block of picture elements is possible.

These and other aspects of the invention are apparent from and will be elucidated with reference to the embodiments described hereinafter.

In the drawings:

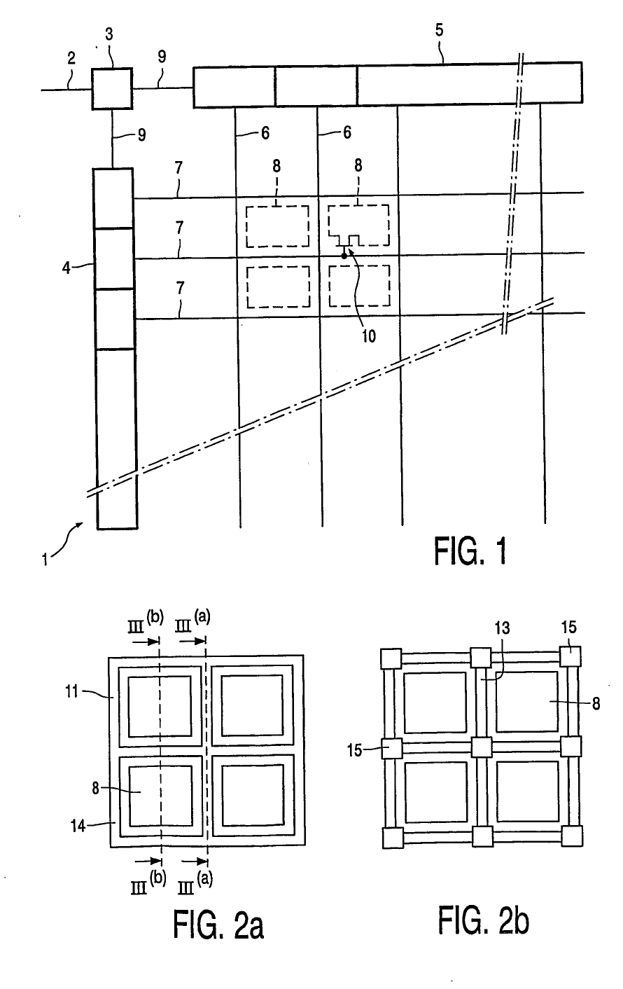

FIG. 1 schematically shows a touch sensitive (liquid crystal) display device,

FIG. 2 shows plan views of a part of a touch sensitive (liquid crystal) display device according to the invention at a bottom plate and at a top plate,

FIG. 4 shows cross-sections along lines III^{a}-III^{a} and III^{b}-III^{b} in FIG. 2, while

FIG. 4 shows a conductive grid for use in the embodiment of FIGS. 2,3 and

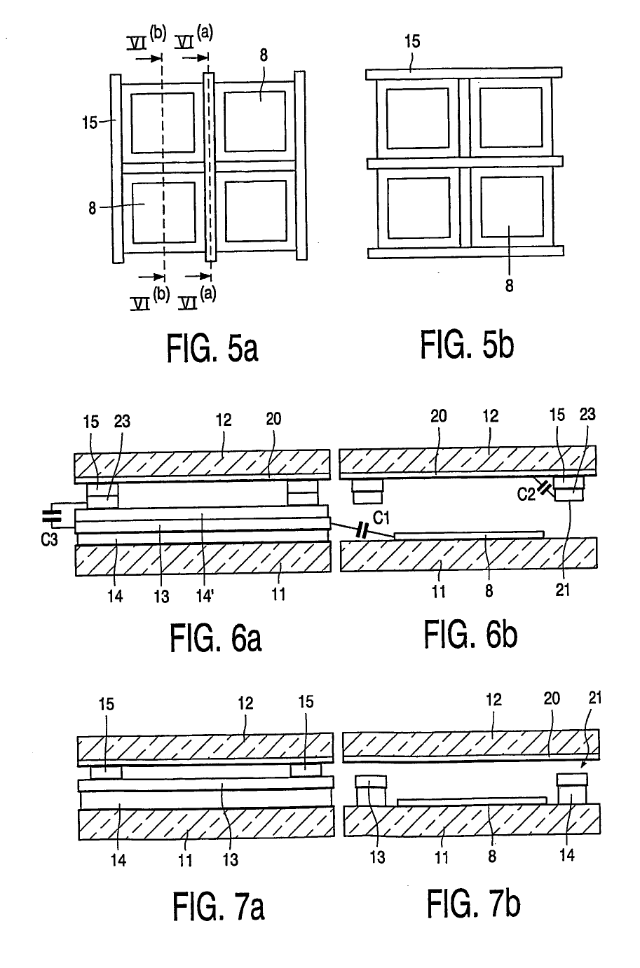

FIG. 5 shows plan views of a part of a further touch sensitive (liquid crystal) display device according to the invention at a bottom plate and at a top plate,

while FIG. 6 shows cross-sections along lines VI^{a}-VI^{a} and VI^{b}-VI^{b} in FIG. 5 and

FIGS. 7-9 show further embodiments of a part of a touch sensitive (liquid crystal) display device according to the invention.

The Figures are diagrammatic and not drawn to scale. Corresponding elements are generally denoted by the same reference numerals.

FIG. 1 is an electric equivalent circuit diagram of a part of a touch sensitive display device 1 to which the invention is applicable. It comprises in one possible embodiment (one mode of driving, called the “passive mode”) a matrix of pixels 8 defined by the areas of crossings of row or selection electrodes 7 and column or data electrodes 6. The row electrodes are consecutively selected by means of a row driver 4, while the column electrodes are provided with data via a data register 5. To this end, incoming data 2 are first processed, if necessary, in a processor 3. Mutual synchronization between the row driver 4 and the data register 5 takes place via drive lines 9.

In another possible embodiment (another mode of driving, called the “active mode”) signals from the row driver 4 select the picture electrodes via thin-film transistors (TFTs) 10 whose gate electrodes are electrically connected to the row electrodes 7 and the source electrodes are electrically connected to the column electrodes. The signal which is present at the column electrode 6 is transferred via the TFT to a picture electrode of a pixel 8 coupled to the drain electrode. The other picture electrodes are connected to, for example, one (or more) common counter electrode(s). In FIG. 1 only one thin-film transistor (TFT) 10 has been drawn, simply as an example.

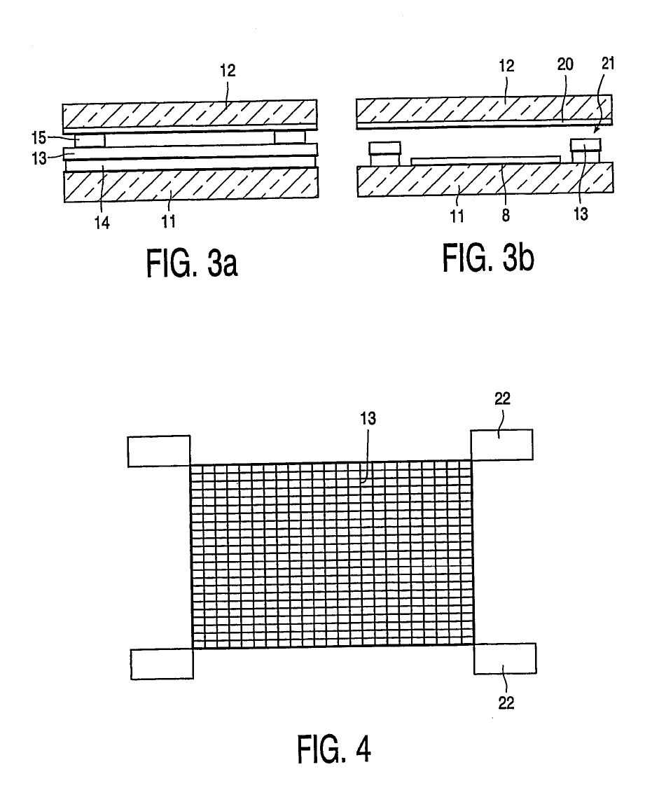

FIG. 2 shows plan views (FIGS. 2a, 2b) and FIG. 3 shows cross-sections along lines III^{a}-III^{a} and III^{b}-III^{b} in FIG. 2a of a part of a touch sensitive liquid crystal device having a bottom substrate 11 and an upper substrate 12. The touch sensitive liquid crystal device has picture electrodes 8 on the bottom substrate 11. The picture electrodes are surrounded by, in this case rectangular, spacer parts 14 for example deposited (by means of e.g. photolithographical techniques) on said bottom substrate 11. On the other substrate 12, bearing an electrode 20, distributed spacer parts 15 are deposited (prepared for example by means of e.g. photolithographical techniques) in such a way that after bringing the substrates together, to obtain a defined cell gap of the liquid crystal device, filling openings 21 remain.

According to the invention a conducting spacer part 13 is introduced between the spacer parts 14 and the distributed spacer parts 15, in this embodiment having substantially the same layout as the rectangular spacer parts 14. A good material for the conducting spacer parts 13 is for example one of the metals aluminum or silver.

Capacitive touch sensing by touching the change of capacitance between e.g. electrode 20 and the conducting spacer parts 13 is realised by determining the AC impedance of the grid of conducting spacer parts 13 at a certain number of points, for example at the four corners (FIG. 4) by means of voltage or current sensors 22. By touching the screen, the capacitance to the grid locally increases. This will generate a different signal at the 4 corners, depending upon the distance of the touch position to the sensors. In this way the position co-ordinates are detected.

If only a limited touch sensing function in one direction is required (for example in combination with a scrolling menu feature) capacitive touch sensing with a conducting spacer part is straightforwardly implemented. In such an embodiment the spacers are structured in the form of strips, running across the entire display. Filling of the display (for example with liquid crystal material) is readily achieved, as open channels are automatically available between the structured spacers.

Integral capacitive touch sensing is realized again in any of the known methods and the position co-ordinate identified by detecting which of the spacer lines registers the largest signal.

In general the pixel capacitance of one pixel is overshadowed by the capacitance of other pixels (in passive matrix), cross overs and stray capacitances (active matrix) in the columns and rows. This reduces the sensitivity.

One solution to this is to ensure that many pixels along the column 6 (or row 7) are sensed at the same moment. In this case, the touch signal will increase with the number of pixels being sensed, whilst the background capacitance will remain constant. In this way the signal to noise ratio will increase. In a preferred embodiment, the touch sensing procedure will involve many rows 7 being addressed at the same time (active matrix) or many columns 8 being connected to increase the touch signal.

FIGS. 5 and 6 show a further embodiment of a touch sensitive display device according to the invention based on capacitive detection methods. The spacing elements 14, 15 are structured in the form of strips, which are located along the entire length and width of the display. Both substrates are provided with these spacing elements, but their orientation is mutually perpendicular. On one substrate e.g. the upper substrate 12, the spacing elements contain an insulating spacer part 15 and conducting spacer parts 23 like metal strips. On the other, bottom substrate 11 the spacing elements contain conducting spacer parts 13 like metal strips with insulating spacer parts 14, 14′ on both sides.

The display device is finalized, in a method known in the art, by aligning and contacting the two substrates. In this way open channels are realized for filling of the cells with liquid crystal material. In this way, four electrically conducting electrodes are realized—picture electrode 20 (e.g. a part of a row)—conducting spacer part 23 e.g. a set of strips—conducting spacer parts 13 e.g. a set of strips—picture electrode 8 (e.g. a part of a column).

Capacitive touch sensing is performed by one of the methods known in the art. The position co-ordinates are identified by detecting capacitance changes between spacer grid 13 and the column (picture) electrode 8 (C1, x-direction) and spacer grid 23 and the row (picture) electrode 20 (C2, y-direction). In this way the touch position is determined without any interference with the working of the display device itself (i.e. it is no longer necessary to drive display pixels for displaying images and for detecting touch information separately).

In a special embodiment the insulating spacer parts 14 between the conducting spacer parts 13, 23 comprise deformable or compliant insulating material, leading to a capacitance C3, which now varies with touching. it is now also possible to determine the touch position by measuring the change in capacitance C3. This has advantage that the measurement will now be much less dependent upon the changes of dielectric constants of liquid crystal material due to its switching behavior by measuring the change in capacitance C3 the position of sensing is determined by a change

Preferably the capacitances C1, C2 and C3 are measured separately. The touch position can be more accurately determined in this case and false touch readings be excluded more easily (C1, C2 and C3 all need to respond to register a touch event).

In the embodiment of FIG. 7 the conducting spacer grid 13 is situated on a thicker continuous structured spacer part 14 on substrate 11, while the second substrate 12 is provided with thinner structured spacer parts 15. By creating such a small distance between electrode(s) 20 and the structured spacer part 14, touch sensing can be carried out by causing a local short circuit between the (exposed portion of the) conducting grid 13 and the electrode 20. Detection can be carried out by means of resistive touch sensing methods known per se e.g. by sequentially applying voltages in two directions and measuring the voltage detected at the touch position and determining the position by resistive division. This is applicable both to active matrix displays (as they have a continuous counter electrode) and to passive matrix displays e.g. by shorting the electrodes on (top) substrate 12 and detecting signals on the conducting grid 13 by means of said resistive touch sensing methods.

Preferably, for displays with structured electrodes 20 on the upper substrate 12, these electrodes 20 are used to determine the touch position (the co-ordinate) in one direction (the x-direction) by determining which electrode was shorted and a similar resistive division approach is used to determine the touch position (the co-ordinate) in the other direction (the y-direction). This has the advantage of high accuracy without further requirements for temperature compensation of the sensor (as known per se for prior art resistive touch sensors).

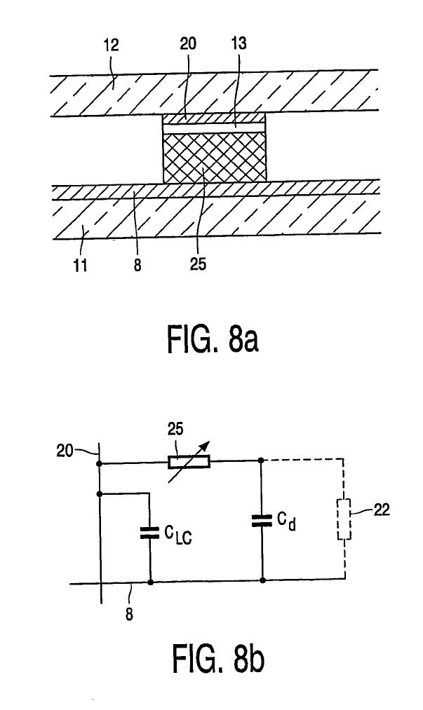

FIG. 8(a) together with its electrical equivalent in FIG. 8(b) (in this case of single liquid crystal picture element) show a further embodiment in which the spacing element comprises a non-linear resistive element 25 and an insulating part 13 between electrodes 8, 20 which are in this example column and row electrodes of a (passive) matrix. Non-linear pressure sensitive resistance material (which drastically reduces its resistance when pressure is applied) is known from e.g. WO 99/38173.

If no pressure is applied the capacitance C_{d} is determined by insulating layers 13, 25 and will have a low value. When pressure is applied C_{d} will rise, since it is only determined by insulating layer 13.

The touch position will be directly measured in x and y directions (as column parts 20 and row parts 8 of the spacers will be contacted at these positions) by a (schematically shown) measuring device 22 (current or voltage detection circuit).

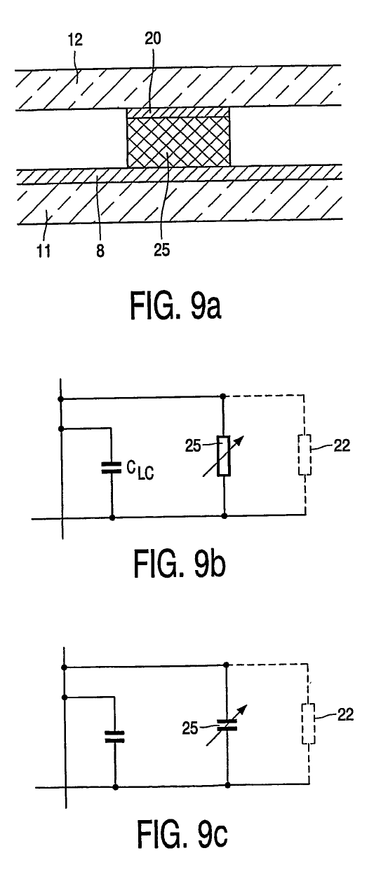

In the embodiment of FIG. 8 the insulating part 13 between electrodes 8, 20 may even be deleted as shown in FIGS. 9(a) and 9(b). FIG. 9(c) finally shows how a piezoelectric spacing part is used, which behaves as a variable voltage source 25′. Pressure on the piezoelectric spacers will directly lead to an output voltage signal, which is used to determine the touch position. For x,y touch sensing, this is easily accomplished by using a continuous mesh of the piezoelectric element and positioning four sensors 22 at the corners of the mesh (similar to the scheme of FIG. 4). Alternatively more sensors can be employed to improve the accuracy of sensing. In stead of a grid sets of strips can be used, similar to the embodiment of FIGS. 5, 6.

The protective scope of the invention is not limited to the embodiments described, while the invention is also applicable to other display devices, for example, plasma displays, and other display devices using spacing devices (display devices on electrophoretic effect, electrowetting, electotochrome effects or foil displays).

Alternatively, flexible substrates (synthetic material) may be used (wearable displays, wearable electronics).

The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. A touch sensitive display device comprising a multiple of picture elements between two substrates, having spacing means between the substrates and means for applying driving voltages to at least one of said picture elements together with means for monitoring the electrical characteristics of at least one of said picture elements or the electrical characteristics of the spacing means and sensing a change in said electrical characteristics the spacing means being part of said means for monitoring the electrical characteristics.

2. A touch sensitive display device as claimed in claim 1 with means for monitoring the impedance of at least one of said picture elements and sensing a change in said impedance the spacing means being part of said means for monitoring the impedance.

3. A touch sensitive display device as claimed in claim 1 in which the means for sensing the change in said impedance measure impedances of different groups of picture elements substantially simultaneously.

4. A touch sensitive display device as claimed in claim 1 in which the spacing means at least have a conducting part.

5. A touch sensitive display device as claimed in claim 4 in which the conducting part of the spacing means is in the form of a grid or in the form of sets of strips.

6. A touch sensitive display device as claimed in claim 1 in which the spacing means at least have a nonlinear resistive part.

7. A touch sensitive display device as claimed in claim 6 in which the nonlinear resistive part of the spacing means is in the form of a grid or in the form of sets of strips.

8. A touch sensitive display device as claimed in claim 1 in which the spacing means comprise a piezoelectric part.

9. A touch sensitive display device as claimed in claim 8 in which the nonlinear resistive part of the spacing means is in the form of a grid or in the form of sets of strips.

10. A touch sensitive display device as claimed in claim 1 in which the means for monitoring the electrical characteristics monitor at least one row of picture elements.

11. A touch sensitive display device as claimed in claim 1 in which the means for monitoring the electrical characteristics monitor at least one column of picture elements.

12. A touch sensitive display device as claimed in claim 1 in which the means for monitoring the electrical characteristics monitor a block of picture elements.
